(19) United States
(12) Patent Application Publication
(10) Pub. No.: US 2016/0119391 A1
(43) Pub. Date: Apr. 28, 2016

(54) DREAM SHARING, VISUALIZATION, AND REALIZATION PLATFORM

(71) Applicant: Richard Anthony Hunter, Kennesaw, GA (US)

(72) Inventor: Richard Anthony Hunter, Kennesaw, GA (US)

(21) Appl. No.: 14/986,396

(22) Filed: Dec. 31, 2015

Related U.S. Application Data
(63) Continuation-in-part of application No. 14/022,220, filed on Sep. 9, 2013, now abandoned.

(51) Int. Cl. H04L 29/06; G07C 13/00; G06T 11/60

(52) U.S. Cl. CPC H04L 65/4061; G06T 11/60; G07C 13/00

(57) ABSTRACT

Embodiments of the present disclosure may provide a platform for dream sharing and visualization. First, a description of a dream may be received. The description may comprise a text and/or an image. Then the description may be published to the platform. A user may then pay a fee to have the dream visualized. In various embodiments, the description of the dream may be submitted for a vote by other users of the platform. When the dream is submitted to a vote and receives enough votes, the platform may provide a visual representation of the dream to the user who submitted the description of the dream. The visualization may then be published to the platform.

### RELATED APPLICATIONS

Under provisions of 35 U.S.C. §119(e), the Applicant claims the benefit of U.S. provisional application No. 61/699,117, filed on Sep. 10, 2012, which is incorporated herein by reference.

The present application is further a continuation-in-part of U.S. patent application Ser. No. 14/022,220 filed on Sep. 9, 2013, the contents of which is incorporated by reference herein in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to content creation, particularly user created content based on the user's subconscious mind.

### BACKGROUND

Every year an absurd tragedy occurs in our lagging market economies. In the United States, an abysmal 80% of product launches may fail because the traditional market research surveys cannot reliably predict consumer behavior. Organizations, such as media companies, video game developers, advertisers, and marketers spend billions of dollars each year on ineffective market research. The purpose of such market research is to provide data on their respective consumers. Organizations use may this data to provide solutions in the form of services and products that fulfill the demands of the consumers. However, these methods of market research may be ineffective. For example, many traditional methods of market research collect data from consumers' conscious mind. Surveys, questionnaires, focus groups, and interviews may all question and engage the consumer at the conscious level. The conscious mind acts as a filter and mediates consumers' true desires.

An interpretation of the basic conclusions of Rational Emotive Behavioral Therapy may suggest that humans make the vast majority of decisions subconsciously. And in fact, it may be said that markets often fail because consumers, unaware of their subconscious desires, may not be able to articulate their deeper desires. As a result, companies fail to reach these unmet hidden needs. For too long, organizations have been asking questions to the wrong part of the mind. In order to understand consumer behavior, it is imperative to understand the subconscious mind.

The subconscious mind is thought to be expressed in dreams, and is seen as the source of automatic thought. The subconscious is more easily influenced by impulses of emotion than by impulses originating solely in the conscious analytical mind. There is much evidence to support the theory that only emotionalized thoughts have any actionable influence upon the subconscious mind and human behavior. Emotion rules the majority of people. Many believe that humans are not thinkers who feel, we are feelers who think. To understand human behavior, we may first need to understand the subconscious mind.

Dreams may be the expressions of the wants and desires of the subconscious mind. If dreams are understood, then we may be able to understand the true desires of the dreamer (e.g., the consumer). Dreams mainly occur in the rapid-eye movement (REM) stage of sleep, when brain activity is high and resembles that of being awake. During this time the pineal gland may secrete a neurotransmitter called Dimethyltryptamine (DMT). Some have proposed that the release of DMT is mechanism that causes the deep sleep visions.

The average individual spends eight hours a day sleeping. During this time, the individual may enter a dream world, where inhibitions can become freedoms. We spend a third of our lives sleeping, but we don't really understand dreaming. Why do we dream? Where does our conscious go for the vast majority of the night, every night?

Scholarly interest in the process and functions of dreaming has been present since Sigmund Freud's interpretations in the 1900s. The neurology of dreaming has remained misunderstood until recent developments. Modern techniques of brain imaging have provided new opportunities for the study of the subconscious mind. New technologies have provided a better understanding of dreams. However, many questions, in regards to their function and content, have yet to be answered.

In order to launch a successful product and conduct effective market research, organizations may need to understand the subconscious mind. Unfortunately, there is a fatal flaw in research of the dreaming, subconscious mind: the scope of the study. To understand dreams and the subconscious mind, research may need to be conducted on a global scale, not on an individual scale.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a flow diagram illustrating a method for sharing, visualizing, and realizing a representation of a dream story;

FIG. 2A is a flow diagram illustrating a method for creating a virtual and digital representation of a single dream story from a single user;

FIG. 2B is a flow diagram illustrating a virtual and digital representation of a multiple dream stories from multiple users; and

FIG. 3 is a block diagram of a system including a computing device for performing the methods.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of dream sharing, embodiments of the present disclosure are not limited to use only in this context.

I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

Embodiments of the present disclosure may provide a platform for dream sharing, visualization, and realization. There is a fundamental functional difference between sharing a dream and sharing a story, as referenced in Culbert, 2008. Similar to how the patented Zaltman metaphor elicitation technique (ZMET) uses a stimuli (in this case visual) to elicit both conscious and especially subconscious thought, this platform may elicit response from both conscious and especially subconscious thought, in the form of a dream description.

To elicit the most accurate subconscious thought, the platform may act as an alarm to wake the user. To turn off the alarm, the user may share a description of their dream. The description may be submitted in vocal or other forms and converted into text and analyzed by the platform. The analysis of the text from the dream descriptions is what makes sharing dreams functionally different than sharing stories, new stories, or story lines. Unlike the content of stories, the analysis of dreams represents meaningful subconscious thought and can be valuable to market research if analyzed correctly, just as the analysis in the patented ZMET process analyzes the conscious and subconscious thought through the use of images, and provides value to market research.

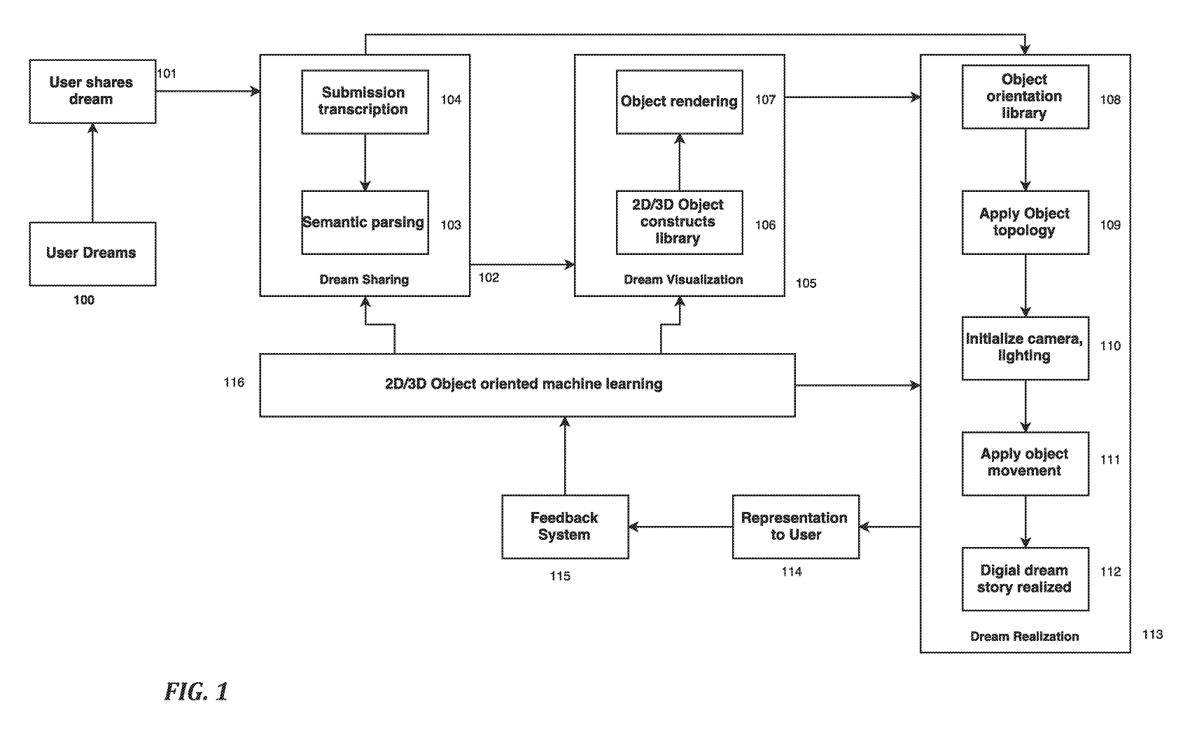

As seen in FIG. 1, this embodiment could transform both dreams and stories into digital and tangible representations without human intervention. There may be 3 distinct processes: Dream Sharing (DS), Dream Visualization (DV), and Dream Realization (DR).

To begin the process, the user may share a dream or story description 101. In the future, this sharing process could change drastically as technology becomes more advanced. The description is sent to the DS process 102. The description may be automatically translated into text 103. The text may be parsed automatically using natural language processing 104 and passed to the DV process 105. The DV may contain a library of 2D or 3D object constructs 106. Object constructs are mathematical algorithms, which produce an almost limitless amount of known objects. The DS text may determine what object constructs to automatically generate. The object constructs may be rendered with texture, color, shading, etc to create digital object assets 107. This digital object may be sent to the DR process 113. Once in the object orientation library and using the DS text output as an input, the digital objects may be combined, manipulated, and orientated to create more complex assets and virtual environments 108. Object topology will assist the orientation library in creating complex digital assets with multiple objects 109. With the objects and complex environments automatically generated, a virtual camera and lighting may be placed in the scene 110. This camera may take video or still images. The objects may then have movement applied along with camera motion, generated with mathematical algorithms 111. Finally, the outputs from the camera, object movements, and DS text output may be realized in multiple embodiments, both digital and tangible representations 112. The functions of 113 are determined based on the DS text output. The representation is sent to the user 114. The user then provides feedback and specific ratings regarding the representation 115. This feedback is unique because it directly integrates into the machine-learning engine, which may assist and train the present disclosure to improve the creation of DV and DR outputs. 116. The DR process may have the ability to produce multiple embodiments. Every dream or story shared in the DS process may be digitally generated automatically and may have the ability to also generate tangible representations.

In accordance with to various embodiments of the present disclosure, the subconscious may be monetized through tangible and visual representations of dreams and stories. The flexibility inherent within this methodology may allow for multiple embodiments to be created. In this way, users may help to create their own visual and tangible representations. In addition, global dream studies may be conducted on these dreams to begin to understand the collective subconscious for the purpose of market research.

The advantage of this embodiment may be at least twofold: One, it may create visual and tangible representations based on the subconscious mind of the consumer, circumventing the need for traditional market research. Two, it may afford an opportunity to broaden the scope of dreams studies, beyond the individual level, to the global collective level. Other advantages of one of more aspects will be apparent from a consideration of the drawings and ensuing description.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

II. Platform Operation

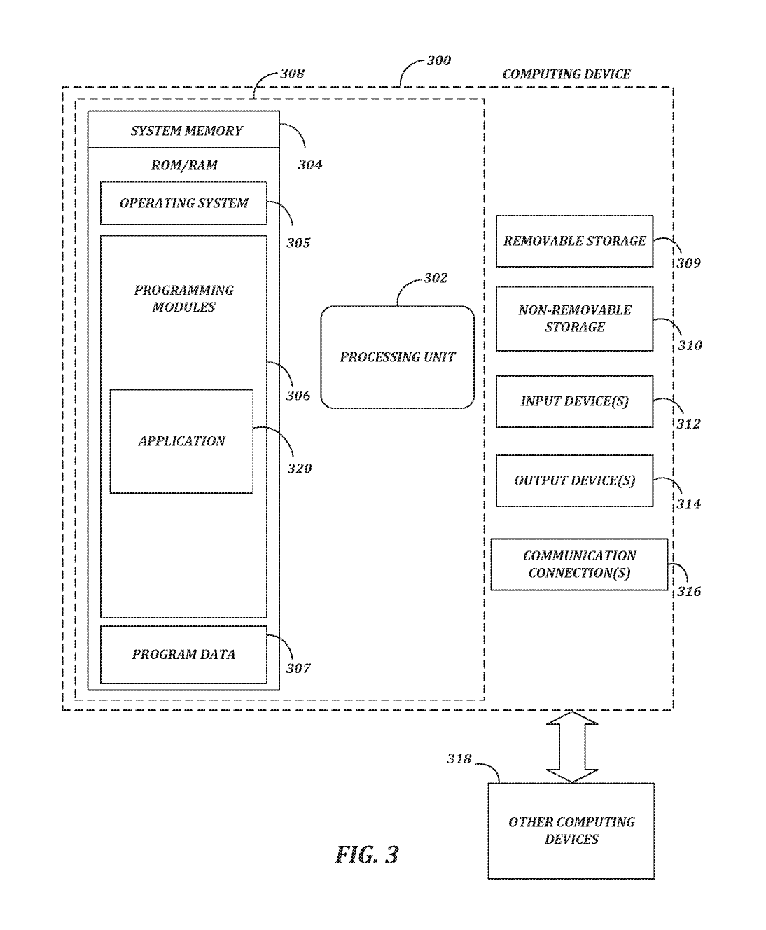

FIG. @ is a flow chart setting forth the general stages involved in a method @00 consistent with an embodiment of the disclosure for providing the dream sharing and visualization platform. Method @00 may be implemented using a computing device 300 as described in more detail below with respect to FIG. 3.

Although method @00 has been described to be performed by the platform, it should be understood that computing device 300 may be used to perform the various stages of method @00. Furthermore, in some embodiments, different operations may be performed by different networked elements in operative communication with computing device 300.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method @00 will be described in greater detail below.

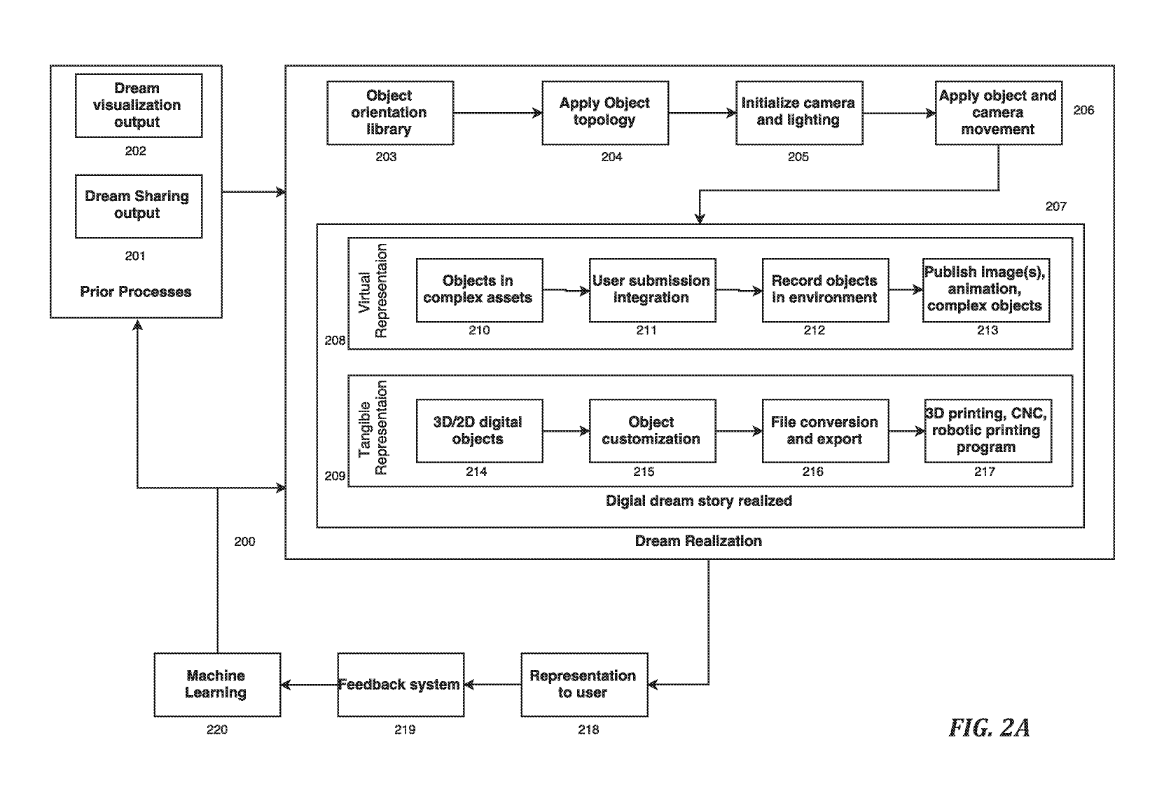

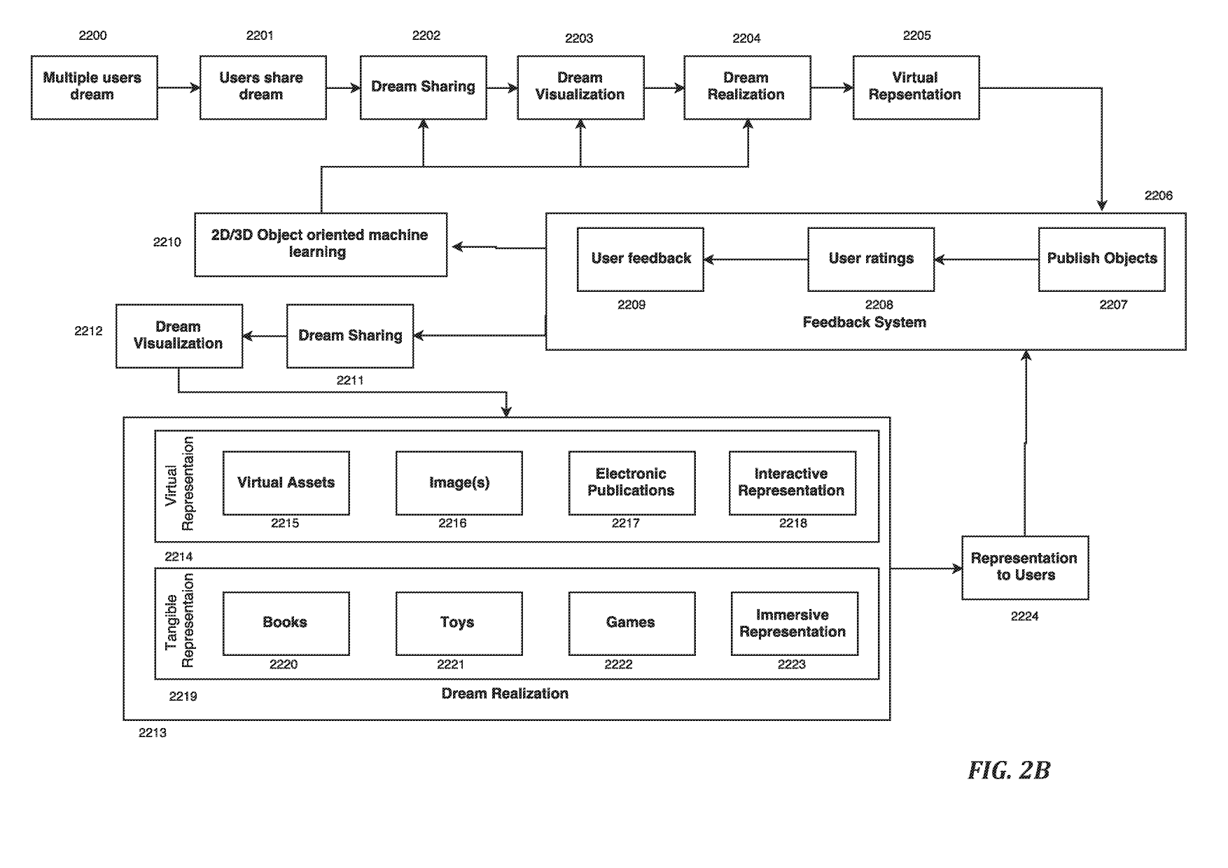

FIG. 1 is a flow diagram illustrating the general process for transforming a Dreamer's dream into any embodiment. Further described in FIG. 2A is the DR process for a single Dreamer input, which may generate tangible and virtual representations.

The method begins with the digital objects and user submission outputs of the Dream Sharing process 201 and Dream Visualization process 202, which are used as inputs to the Dream Realization process 200. Once in the object orientation library the digital objects may be combined, manipulated, and orientated to create more complex assets and virtual environments 203. Object topology will assist the orientation library in creating complex digital assets with multiple objects 204. With the objects and complex environments automatically generated, a virtual camera and lighting may be placed in the scene 205. This camera may have ability to take record video or still images. The objects may then have movement applied along with camera motion, generated with mathematical algorithms 206. Finally, the outputs from the camera, object movements, and DS text output may be realized in multiple embodiments, both virtual and tangible representations 207. Virtual representations may include but are not limited to electronic publications, virtual assets, images, series of images, etc 208.

The virtual representation method may begin with the objects is placed in the complex environment with many generated objects 210. The user submission may then be integrated into the file, whether through text, voice, visual, or other formats, such as physiological or neurological submissions 211. Once the virtual objects and environments are generated, they may be recorded 212. These recordings may have virtual outputs of images, series of images, animation, and complex objects such as virtual worlds and environments, which create the virtual representations of the dream story 213. These objects do not have to be recorded, but they may be exported to other virtual environments. The tangible representation method may begin with the 2D/3D objects 214.

These models should be ready for tangible transformation; however, it may be exported to a modeling tool for customization 215. The object may be converted to correct file format for export 216. The object file may be import into various printing, 3D printing, robotic printing, CNC, and other software to be created into a tangible representation of the dream story 217. The DR process may output a multitude of tangible or virtual representation to the user 218. Examples of specific outputs from the DR process can be seen in FIG. 2B. The user may provide specific feedback regarding the output 219. This feedback may be used in the machine learning process 220. This process may train the algorithms across the platform.

Another embodiment of the present disclosure, as shown in FIG. 2B, demonstrates the transformation of dream story descriptions from multiple users. In this embodiment, multiple users dream 2200 and may share their dream stories 2201. Similar to processes in FIG. 1, the dream story description may be transcribed and parsed in DS 2202, the objects may be generated and rendered in DV 2203, and the DR process 2204 may output a virtual representation 2205. The users, who may provide their thoughts to the feedback system 2206, may view this representation when it is published 2207. Users may rank and rate the representation 2208. These rankings may be calculated based on explicit user rankings and implicit user behavior analyzed when interacting with the virtual representations.

Dreamers may also provide explicit feedback to improve the representations in the future 2209. The feedback system feeds into the machine learning process, which again may train the algorithms throughout the system 2210. The feedback system may also resubmit the dream story description, along with the Dreamer ranking and feedback to the DS process 2211. The DS process may reparse the description with the new information to generate new 2D/3D objects in the Dream Visualization process 2212. Only objects that received the highest rankings in the feedback system may be created in DV process and output to the DR process 2213. These objects may be output in virtual and tangible formats.

Virtual representations may include but are not limited to electronic publications, virtual assets, images or series or images, interactive games, etc 2214. Simple virtual assets may be created during the DV process, but these simple assets may be brought together to create complex virtual assets 2215. Once the complex virtual assets are created, a virtual camera may record still images, a series of images, or continuous video. Movement may be applied to the objects and camera through the image frames, which may generate an animation 2216. To create electronic publications, the text from the dream story submissions from the multiple Dreamers may be accurately overlaid on or around the images 2217. There are various possibilities that can embody a electronic publication representation, of the Dreamer's dream; these may comprise, but are not limited to: a) short story, b) novel, c) graphic novel, d) comic book, and e) animation.

The most complex virtual representation is the interactive representation 2218. There are various possibilities that can embody an interactive virtual representation of the Dreamers' dreams; these may comprise, but are not limited to: a) video game and b) an interactive story board that may allow Dreamers to manipulate characters and environments to create stories. Various embodiments may integrate the favorite or most popular dreams stories from many Dreamers into a virtual representation, thus forming a virtual representation of the collective subconscious.

Tangible representations may include but are not limited to Books, Toys, Games, and Immersive Representations 2219. Similar to how the electronic publications are created, the images, including or not including the text from the dream story description, may be combined, then be printed, bound, and created into various embodiments such as books, short stories, graphic novels, flip books, etc 2220. The objects generated in the DV process may also be sent to CAD or 3D modeling programs for printing, milling, sewing, manufacturing, etc 2221. This process may create various toys such as dolls, action figures, models, kits, etc.

By combining the printed images and 3D printed or manufactured objects, games can be generated based on dream descriptions and the user feedback system 2222. Once many objects generated and have been through the feedback system, the DR may produce large tangible immersive representations of the most favorite and highest ranked objects and complex assets 2223. There are various possibilities that may embody an immersive tangible representation of the Dreamer's dreams; these may comprise, but are not limited to: a) adventure park and b) theme park. These immersive representations may be modularly prefabricated, based on objects automatically created, rendered, published, and polished through the feedback system, and installed on site. Various embodiments may integrate the favorite or most popular dreams stories from many Dreamers into a digital representation, thus forming a tangible representation of the collective subconscious.

Though the sharing, visualization, and realization of dream stories on the platform, in various embodiments, the information may be collected from the dreams. Once enough dream information has been collected, dreams can begin to be understood and analyzed dreams on a collective scale. The understanding of the collective subconscious could provide insight into consumers' true desires that may currently be unavailable.

In various embodiments of the present disclosure, there may not be need for marketing research because the content and ideas are generated directly by the consumers and their subconscious mind. This may afford the Dreamers an opportunity to have a voice and presence in any virtual or tangible representation of their dream stories.

By way of example and not limitation, a number of advantages of the various embodiments in the present disclosure may be:
a. Tapping into the infinite supply to dreams to afford Dreamers the opportunity for creative expression;
b. Allowing Dreamers to share and visualize and realize dreams;
c. Allowing Dreamers to obtain virtual and tangible representations of dreams;
d. Allowing Dreamers to create a representation of collective dreams;
e. Giving the Dreamers creative license in creating an animation, book, game, etc, which fosters interaction with the consumer;
f. Circumventing the need for marketing research as its method is founded directly in the subconscious;
g. Providing an opportunity to study the dream subconscious on a collective level rather than an individual level; and
h. Monetizing the subconscious by providing various possibilities of visualizations and representations of dreams.

Consistent with embodiments of the present disclosure, dreamers may share, realize and visualize their dreams through a platform. There are many possibilities for creating representations of said dreams. Although the description above contains many specifications, these should not be construed as limiting the scope of the embodiments but merely providing illustrations of some of the several embodiments. For example, a movie based on the collective dreams of the Dreamers, could be created. Or, the input doesn't necessarily need to be dreams, it can be any type of shared description. As long as the system understands the submission at the object and object orientation level, then it may be able to produce any virtual or tangible representation.

III. Platform Architecture

The platform of the present disclosure may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform may be hosted on a centralized server, such as, for example, a cloud computing service. Although methods have been described to be performed by a computing device 300, it should be understood that, in some embodiments, different operations may be performed by different networked elements in operative communication with computing device 300.

Embodiments of the present disclosure may comprise a system having a memory storage and a processing unit. The processing unit coupled to the memory storage, wherein the processing unit is configured to perform the stages of the above disclosed methods.

FIG. 3 is a block diagram of a system including computing device 300. Consistent with an embodiment of the disclosure, the aforementioned memory storage and processing unit may be implemented in a computing device, such as computing device 300 of FIG. 3. Any suitable combination of hardware, software, or firmware may be used to implement the memory storage and processing unit. For example, the memory storage and processing unit may be implemented with computing device 300 or any of other computing devices 318, in combination with computing device 300. The aforementioned system, device, and processors are examples and other systems, devices, and processors may comprise the aforementioned memory storage and processing unit, consistent with embodiments of the disclosure.

With reference to FIG. 3, a system consistent with an embodiment of the disclosure may include a computing device, such as computing device 300. In a basic configuration, computing device 300 may include at least one processing unit 302 and a system memory 304. Depending on the configuration and type of computing device, system memory 304 may comprise, but is not limited to, volatile (e.g. random access memory (RAM)), non-volatile (e.g. read-only memory (ROM)), flash memory, or any combination. System memory 304 may include operating system 305, one or more programming modules 306, and may include a program data 307. Operating system 305, for example, may be suitable for controlling computing device 300's operation. In one embodiment, programming modules 306 may include application 320. Furthermore, embodiments of the disclosure may be practiced in conjunction with a graphics library, other operating systems, or any other application program and is not limited to any particular application or system. This basic configuration is illustrated in FIG. 3 by those components within a dashed line 308.

Computing device 300 may have additional features or functionality. For example, computing device 300 may also include additional data storage devices (removable and/or non-removable) such as, for example, magnetic disks, optical disks, or tape. Such additional storage is illustrated in FIG. 3 by a removable storage 309 and a non-removable storage 310. Computer storage media may include volatile and nonvolatile, removable and non-removable media implemented in any method or technology for storage of information, such as computer readable instructions, data structures, program modules, or other data. System memory 304, removable storage 309, and non-removable storage 310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 300. Any such computer storage media may be part of device 300. Computing device 300 may also have input device(s) 312 such as a keyboard, a mouse, a pen, a sound input device, a touch input device, etc. Output device(s) 314 such as a display, speakers, a printer, etc. may also be included. The aforementioned devices are examples and others may be used.

Computing device 300 may also contain a communication connection 316 that may allow device 300 to communicate with other computing devices 318, such as over a network in a distributed computing environment, for example, an intranet or the Internet. Communication connection 316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 304, including operating system 305. While executing on processing unit 302, programming modules 306 (e.g., application 320) may perform processes including, for example, one or more of method stages as described above. The aforementioned process is an example, and processing unit 302 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices. Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

IV. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
Receiving at least one input from at least one user, the at least one input being associated with content relating to a dream of the at least one user;
Receiving a request for a visual representation of the at least one input;
Creating the visual representation, the visual representation comprising at least one of the following: a virtual representation and a tangible representation; and
Providing the at least one user with the visual representation.

2. The method of claim 1, further comprising: publishing the at least one input to a platform.

3. The method of claim 2, further comprising: submitting the at least one input to a vote.

4. The method of claim 3, further comprising: receiving, through the platform, votes in favor of a creation of a visual representation of the at least one input.

5. The method of claim 4, further comprising: determining if the votes reach a predetermined threshold.

6. The method of claim 5, when the votes reach the predetermined threshold, further comprising:
a. Creating the visual representation; and
b. Publishing the visual representation.

7. A computer-readable medium comprising a set of instruction which, when executed by a computer, perform a method comprising:
Receiving a description of a dream of a user;
Publishing the description of the dream to an online platform;
Enabling users of the platform to vote in favor of the dream;
Determining if votes for the dream have reached a threshold; and
When the votes for the dream have reached the threshold:
Causing a creation of a visual representation of the dream, the visual representation comprising at least one of the following: a tangible representation and a virtual representation; and
Providing the at least one user with the visual representation.

8. The computer-readable medium of claim 7, further comprising: receiving a payment for the creation of the visual representation.

9. The computer-readable medium of claim 7, wherein the visual representation comprises at least one of the following: an illustration, an animation, an interactive interface, a book, a multimedia representation, a video game, a tangible object, and an immersive.

10. The computer-readable medium of claim 7, wherein the description of the dream comprises at least one of the following: a text and an image.

11. A system comprising:
A memory storage; and
A processing unit coupled to the memory storage; the processing unit being configured to:
Receive a description of a dream of a user;
Publish the description of the dream to an online platform;
Enable users of the platform to vote in favor of the dream;
Determine if votes for the dream have reached a threshold; and
When the votes for the dream have reached the threshold:
Create a visual representation of the dream, the visual representation comprising a tangible object.
